(19) United States
(12) Patent Application Publication
(10) Pub. No.: US 2009/0312865 A1
(43) Pub. Date: Dec. 17, 2009

(54) ARTICLE METERING SYSTEM

(76) Inventors: Jean-Christophe Bonnain, Chateauroux (FR); Pascal Martini, Chateauroux (FR)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/295,032

(22) PCT Filed: Mar. 29, 2007
(86) PCT No.: PCT/US07/65487

§ 371 Date: Sep. 29, 2008

Related U.S. Application Data
(60) Provisional application No. 60/787,798, filed on Mar. 31, 2006.

(51) Int. Cl. B65G 47/08

(52) U.S. Cl. 700/230

(57) ABSTRACT

A system for metering articles (C) includes staging conveyor (16) and a transfer conveyor (26) extending along a conveyor path. The transfer conveyor (26) has at least two independent sets of conveying elements (44, 48). The system also includes a supply unit and a control unit (40). A first set of conveying elements (44) is held stationary at the loading zone while a first group of articles is supplied from the staging conveyor to the loading zone. Thereafter, the first group of articles (C) is moved to the exit point. The control unit also controls a second set of conveying elements (48) such that after the first group of articles is moved from the loading zone, the second set (48) is held stationary at the loading zone while a second group of articles is transferred from the staging conveyor to the loading zone.

### BACKGROUND OF THE INVENTION

This invention relates generally to a system for metering articles such as containers, more specifically, but not exclusively, the invention relates to an apparatus for and method for metering articles during a container-fining process.

The filling of articles such as beverage containers is typically performed using high-speed equipment. Open-top containers are conveyed sequentially to a filler which is used to dispense liquid into the containers. Modern fillers typically operate at high speed, often filling multiple containers simultaneously as the filler rotates while the containers move along a circular path. This provides sufficient “dwell” time for each container at the filling nozzle without requiring that the container be slowed or stopped. An example of such a filler may be seen in U.S. Pat. No. 5,924,482. The filled containers are then conveyed to other equipment used for closing the containers, loading the filled containers into packages, and the like.

Ahead of the filler, the empty containers must be arranged in a linear fashion and transported at a line speed consistent with the filler speed. The empty containers may be supplied to the filling line on pallets in a stacked configuration, in which ease it is necessary for the empty containers to be unloaded from the pallet and placed onto a conveyor in an arranged fashion for transport to the filler. This task may be done manually, which requires a person to perform a repetitive, tedious task. What would be desirable would be to provide automated equipment that can unload the containers from the pallet and supply them to the filler.

Similar needs exist in the industry with respect to beverage manufacturing and packaging, as well as in other arts. For example, it may necessary to direct the tilled containers from the filler area to a packaging machine that arranges the containers into groups of predetermined number and then packages them in a paperboard carton or other package. Equipment is needed to form the groups and to direct the groups into the packaging machine at appropriate speed. Similar needs exist for handling other articles.

### SUMMARY OF THE INVENTION

In accordance with the present invention, an article metering system for metering a plurality of articles such as containers includes staging means for holding a plurality of articles, and a conveyor extending along a conveyor path from a loading zone to an exit point and back to the loading zone. The conveyor has at least two independent sets of conveying elements for moving articles along the conveyor path. Supply means is provided for supplying a group comprising a predetermined number of articles from the staging means to the loading zone. A control means controls the sets of conveying elements whereby a first of the sets is held stationary at the loading zone while a first group of articles is supplied from the staging means to the loading zone, and is thereafter controlled to move the first group of articles to the exit point. The control means also controls a second set of conveying elements such that after the first group of articles is moved from the loading zone, the second set is held stationary at the loading zone while a second group of articles is transferred from the staging means to the loading zone.

The control means may further control the second set of conveying elements to move the second group of articles to the exit point, and may further control the first set of conveying elements such that after the second group of articles is moved from the loading zone, the first set is returned to the loading zone.

The control means may further control the sets of conveying elements such that if a croup of articles is not present at said loading zone, the waiting set of conveying elements is held stationary at said loading zone only a predetermined period before being moved to said exit point.

Alternatively, the control means further control the sets of conveying elements such that if a group of articles is not present at said loading zone, the waiting set of conveying elements is held stationary at said loading zone until a group of articles becomes present at said loading zone.

Optionally, the or each other of said sets of conveying elements are held stationary on said conveyor during the stationary period of said waiting set of conveying elements.

Optionally the groups of articles may be supplied in layers from the staging means to the loading zone in order to minimize or eliminate empty space between groups of containers at the loading zone.

Preferably the article metering system comprises a transfer element disposed at the exit point of the conveyor for receiving a metered stream of articles and for transferring said metered stream of articles to a processing device.

Preferably the article metering system comprises a delivery mechanism for delivering a plurality of articles to the staging means.

According to a second aspect, the invention provides, a method of metering articles, such as containers, comprising providing a plurality of articles to a staging means: conveying said plurality of articles from a loading zone to an exit point using at least two independent sets of conveying elements; supplying a group comprising a predetermined number of articles from said staging means to said loading zone; and controlling said sets of conveying elements whereby a first of said sets is held stationary at said loading zone while a first group of articles is supplied from said staging means to said loading zone, and is thereafter controlled to move said first group of articles to said exit point, and for controlling a second set of conveying elements such that after said first group of articles is moved from sale leading zone, said second set is held stationary at said loading zone while a second group of articles is transferred from said staging means to said loading zone.

Preferably, the step of controlling further comprises controlling said second set of conveying elements to move said second group of articles to said exit point, and for further controlling said first set of conveying elements such that after said second group of articles is moved from said loading zone, said first set is returned to said loading zone.

Alternatively, said step of controlling further comprises controlling the sets of conveying elements such that if a group of articles is not present at said loading zone, the waiting set of conveying elements is held stationary at said loading zone only a predetermined period before being moved to said exit point.

Optionally, the step of controlling comprises controlling the or each other of said sets of conveying elements such that they are held stationary on said conveyor during the stationary period of said waiting set of conveying elements.

Optionally, the step of controlling further comprises controlling the sets of conveying elements such that if a group of articles is not present at said loading zone, the waiting set of conveying elements is held stationary at sale loading zone until a group of articles becomes present at said loading zone.

Preferably, the method comprises supplying groups of articles in layers from the staging means to the loading zone in order to minimize or eliminate empty space between groups of containers at the loading zone. The method may further comprise transferring a metered stream of articles from the exit point to a processing device. Optionally, the method further comprises delivering a plurality of articles to the staging means.

### BRIEF DESCRIPTION OF THE DRAWINGS

FIG. 1 shows a perspective, partially schematic view of a container metering system in accordance with the present invention.

FIGS. 2 and 4-7 are each a perspective, partially schematic view of the container metering system shown in FIG. 1, showing sequential, further steps in its process of operation.

FIG. 3 is a perspective, broken-away and partially schematic view of the transfer conveyor of the system of FIG. 1.

### DETAILED DESCRIPTION OF THE PREFERRED EMBODIMENT

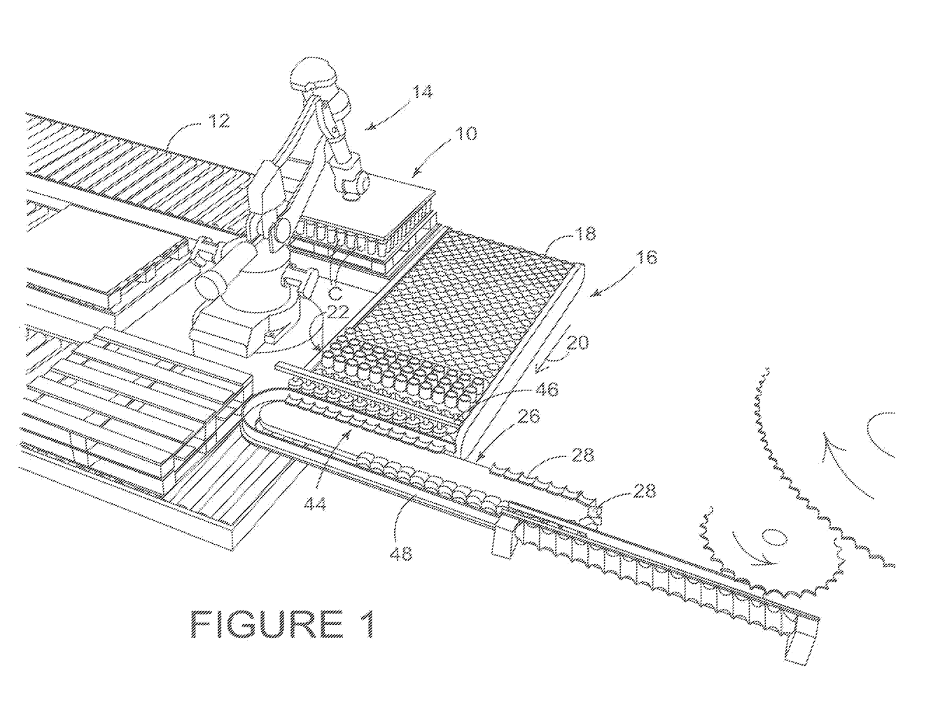

A machine embodying the article metering system of the present invention is shown in FIG. 1. A pallet 10 that includes stacked layers of articles such as open-top, empty beverage containers is moved into the proximity of the machine along a roller conveyor 12. A de-palletizing robot 14 having a programmable arm is used to lift a layer of containers C from the pallet 10 and to place it onto a staging conveyor 16 comprising a series of retaining elements 18 which are moved around a conveyor. Elements 18 form an array of receiving apertures, each capable of holding a container C. The staging conveyor 16, which forms a portion of a staging means for the containers, advances in the direction shown by arrow 20, being moved in an intermittent motion that presents a first row 22 of containers C at the forward end of conveyor 16, stopped in the position shown in FIG. 1.

Other staging means that present the containers C in an organized, predictable manner may be used. For example, the containers may be held on the pallet 10 in stacked trays, with an entire tray being removed from the pallet and placed in position for subsequent handling.

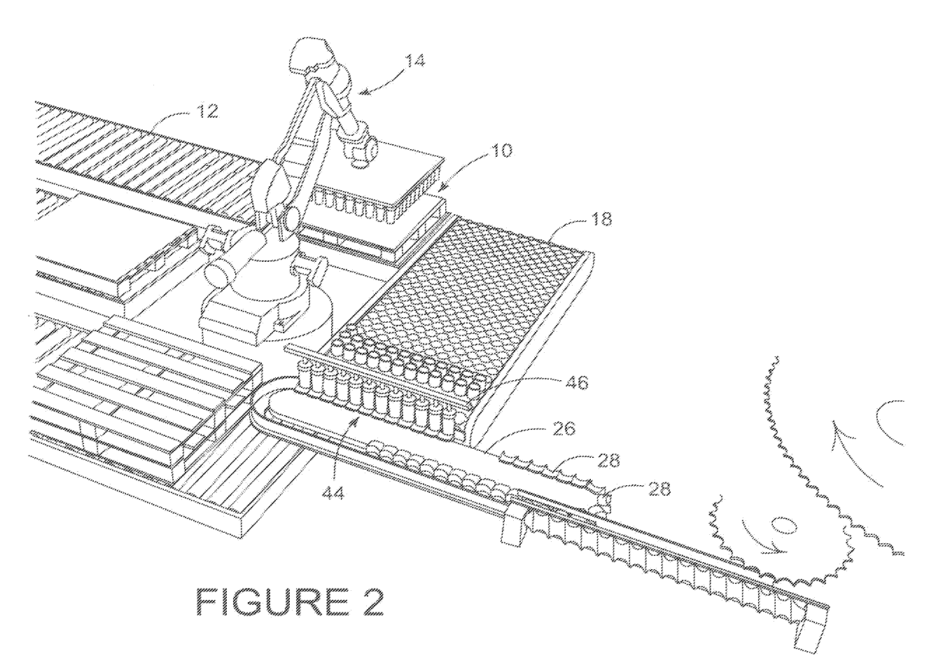

Referring now to FIG. 2, the first row 22 of containers C is engaged by a transfer means which includes lifting means 46 that engages the top of each container C of row 22, e.g., by vacuum, and lifts the row 22 from staging conveyor 16 and places the row of containers C onto the loading zone of a transfer conveyor 26. Transfer conveyor 26 includes a series of container-engaging elements 28, each configured so as to engage a single container C in a recessed lace so that movement of element 28 will result in movement of the container C.

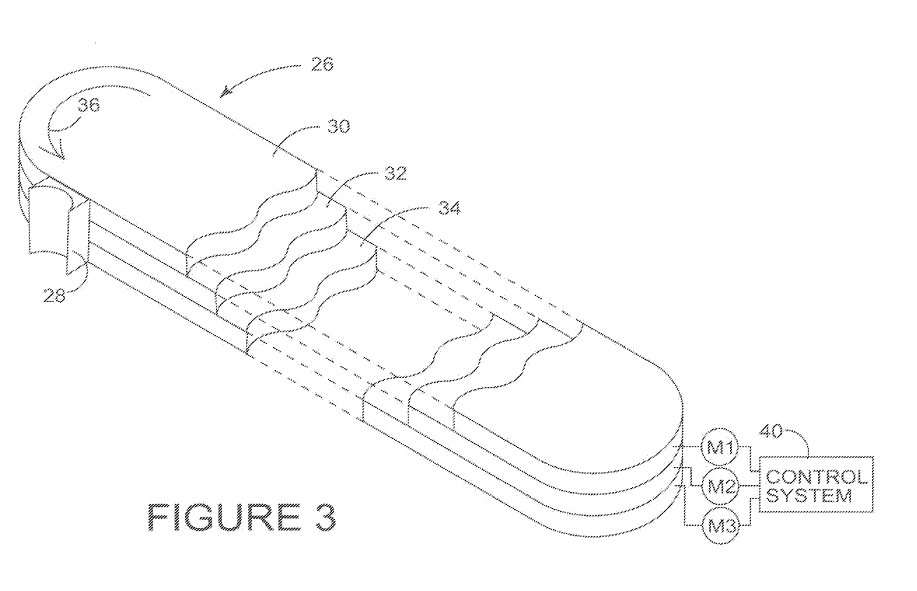

Referring now to FIG. 3, a portion of transfer conveyor 26 is shown schematically. The transfer conveyor 26 includes a plurality of chains, three chains 30, 32, and 34 being shown in this embodiment. The three chains 30, 32, and 34 are stacked in vertical alignment so that, with respect to horizontal, each moves along the same path. Each chain 30, 32, 34 is driven by a separate motor M1. M2, and 1V13 respectively. Each motor M1, M2, and M3 are preferably programmable servo motors, so that while each chain 30, 32, and 34 move along essentially the same path, shown generally by arrow 36, each may be drivers independently of the others. Each engaging element 28 is connected to one (but only one) of chains 30, 32, and 34 in such a manner that the engaging element 28 moves in a path around conveyor 26 that is identical to that of the other engaging elements regardless of which chain 30, 32, or 34 the particular element 28 is connected to.

Motors M1, M2, and M3 are all operated under the control of a programmable control means 40. Control means 40 is conventional in its construction. The programming of control means 40 to accomplish the operation of motors M1, M2, and M3 as described herein will be readily understood by those skilled in the art.

Referring back to FIG. 2, engaging elements 28 are arranged on the conveyor 26 in sets of engaging elements 28 disposed in a side-by-side arrangement along the path of conveyor 26. The number of engaging elements 28 in each set corresponds to the number of receiving apertures provided in each row of staging conveyor 18, and the number of sets corresponds to the number of independent but coincident chains comprising conveyor 26. In the embodiment shown herein, three such sets of engaging elements 28 are provided. A first set 44 is positioned at the loading zone, adjacent to the exit end of the staging conveyor 18, with the engaging elements 28 that form set 44 being aligned with the receiving apertures of the leading row of the conveyor 18.

Lifting means 46 transfers the group of containers C from the leading row on the staging conveyor 18 onto the loading zone of transfer conveyor 26. The lifting means 46 may be, e.g., a vacuum system that engages the containers C, lifts them together as a row from the receiving apertures 18 of the staging conveyor 16, arm places them or transfer conveyor 26 so that one container C is located in the receiving recess of each engaging element 28. The containers C are shown in this position in FIG. 2. Other forms of transfer means may be used, such as a belt conveyor that, intermittently directs articles onto fixed guides that in turn direct the articles onto transfer conveyor 26.

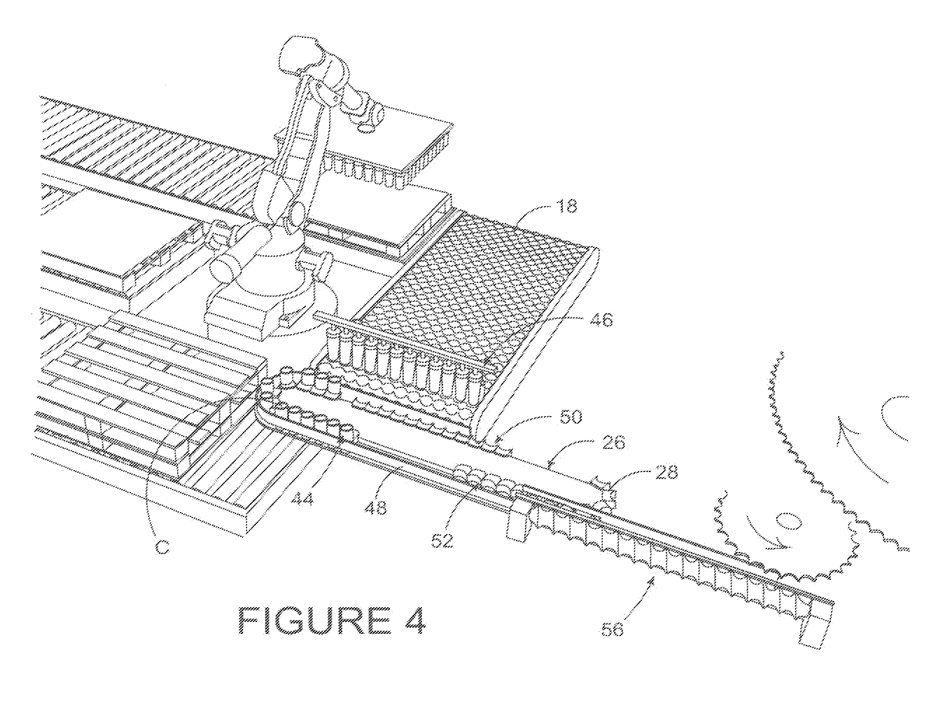

Referring now to FIG. 4, it can be seers that the engaging elements 28 of set 44, and the conveyed containers G, are advanced along transfer conveyor 26. This occurs by selective actuation of the corresponding one of motors M1, M2, and M3, so that each engaging element 28 moves the corresponding container C. A static guide 48 retains the containers on the path of conveyor 26. Meanwhile, a second set 50 of elements 28 is advanced along the transfer conveyor 26 by actuation of a second of the motors M1, M2, and M3 for the purpose of locating the set 50 at the exit end of the staging conveyor 16. At the same time, the lifting means 46 begins to lift the next row of containers C from the staging conveyor 16.

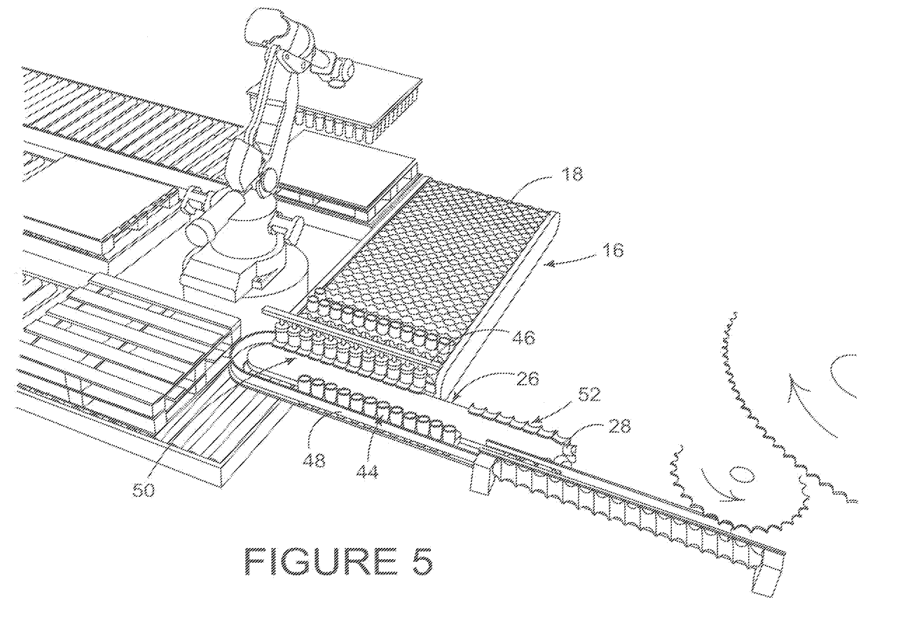

in FIG. 5, it can be seen that the elements of set 50 are brought to a stop at the end of staging conveyor 18, where the containers of the next row are placed by the lifting means 46 into the recesses defined by the elements 28. Meanwhile, set 44 of elements 28 continues to advance its respective containers C along the transfer conveyor 26. A third set 52 of elements 28, driven by a third of motors M1, M2, and M3, is moved towards the loading zone at the end of staging conveyor 16.

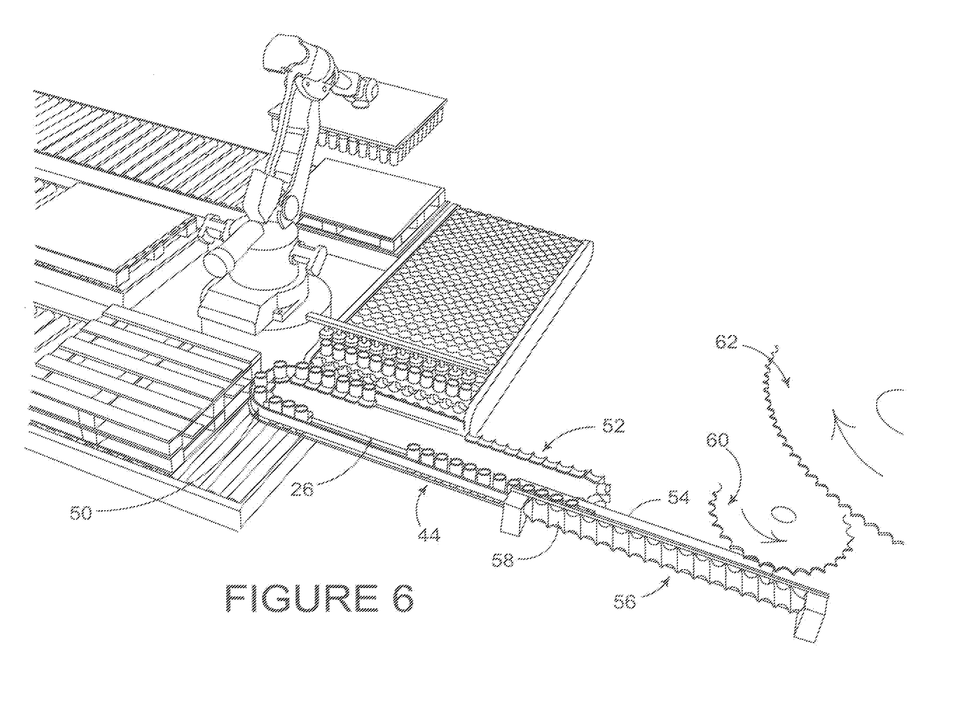

As shown in FIG. 6, the containers C conveyed by the first set 44 of elements 28 continue along the path of transfer conveyor 26 until the containers C reach the exit point of conveyor 26, where they begin to engage stationary guide 54 and an infeed conveyor 56. In this embodiment infeed conveyor 56 may include a screw-type conveyor element 58 having a pitch that is sized to receive a container C within each flight of the screw-type conveyor element 58 so as to advance the containers C along the infeed conveyor 58 and away from the transfer conveyor 26.

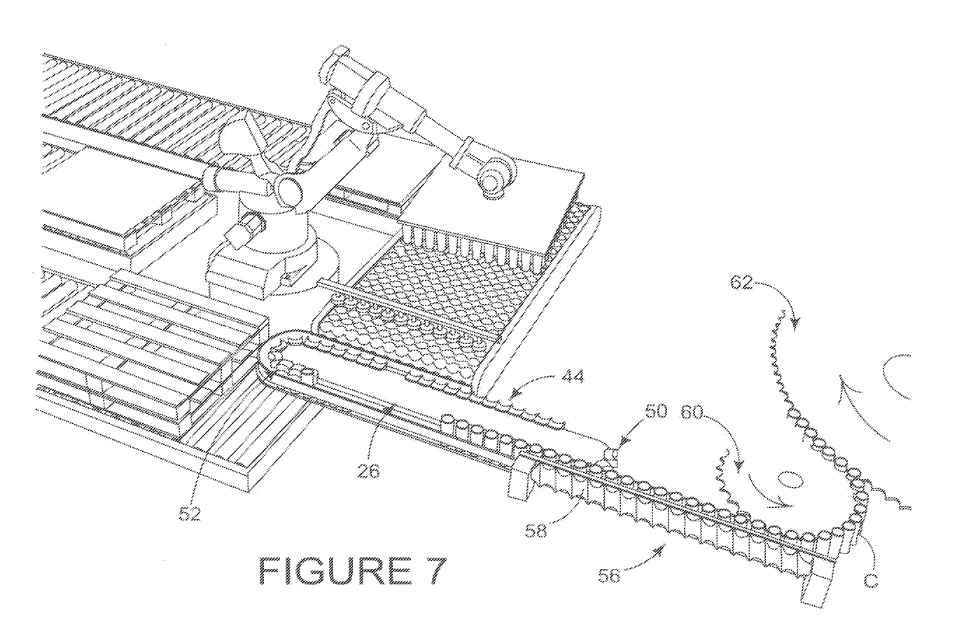

Referring now to FIG. 7, the containers C that had been delivered to the infeed conveyor 56 by the first set 44 of elements 28 have traversed the length of infeed conveyor 56, whereupon they move around a starwheel device 60 and are transferred onto a filling apparatus, illustrated schematically at 62. Meanwhile, the elements 28 of the first set 44 are returned along the return path of transfer conveyor 26. In FIG. 7, the elements 28 are shown approaching the loading zone at the end of the staging conveyor 16, where the elements 28 will be available for loading with additional containers C. The second set 50 of engaging elements 28 is unloading its respective containers C into the infeed container 56, which containers C will join the line of containers C previously deposited by the preceding set. At the same time, the third set 52 is proceeding along transfer conveyor 26 so that any conveyed containers C can be directed into the infeed conveyor 56.

Throughout the sequence shown by FIGS. 2 and 4-7, it can be seen that the de-palletizing robot 14 is progressing to move the next layer of containers C from the pallet 10 onto the staging conveyor 16. For maximum efficiency of operation, it will be appreciated that layers of containers should be supplied to staging conveyor 16 so as to minimize or eliminate empty space between containers C on the conveyor 16, although the container metering system can accommodate breaks in the supply of containers C. In one embodiment, when a set 44, 50, or 52 of elements 28 arrives at the exit end of staging conveyor 16 and no containers C are present, the set will wait the normal time increment and then proceed around conveyor 26 even though the elements 28 may be empty. Alternatively, the control system 40 for motors M1, M2, and M3 may be programmed so that the set 44, 50, 52 will simply wait at tire loading point for containers C to arrive from staging conveyor 16. In this latter case, some containers C may be halted on the conveyor 26 until additional staged containers C reach the loading zone.

While the container metering system is described herein as used as part of a container filling operation, it will be appreciated that the invention may be used in any operation in which it is desired to take articles delivered in bulk and supply them in metered fashion to a subsequent operation. For example, the system could be used to take filled, individual containers delivered on pallets and supply them to the infeed of a packaging machine for placing the filled containers into a carton. Alternatively, the system could be used to supply articles of any type to, for example, a processing station where the articles are painted or labeled. Many other uses will be apparent to those skilled in the art.

In addition it is envisaged that any set of engaging elements held stationary at the loading zone so that a group of containers can be loaded into the set of engaging elements 46, 48, 50 will be held stationary only relative to the group of articles and in absolute terms both the group of articles and set of conveying elements may be moving but relative to one another are both stationary. It is also envisaged that alternatively, the group of elements will only be held substantially still or will be allowed to move, providing that the movement relative to the group of containers C enables loading of the group of containers into the set of engaging elements 46, 48, 50.

1. An article metering system for metering a plurality of articles such as containers, comprising:
staging means for holding a plurality of articles;
a conveyor extending along a conveyor path from a loading zone to an exit point and back to said loading zone;
said conveyor having at least two independent sets of conveying elements for moving articles along said conveyor path;
supply means for supplying a group comprising a predetermined number of articles from said staging means to said loading zone; and
control means for controlling said sets of conveying elements whereby a first of said sets is held stationary at said loading zone while a first group of articles is supplied from said staging means to said loading zone, and is thereafter controlled to move said first group of articles to said exit point, and for controlling a second set of conveying elements such that after said first group of articles is moved from said loading zone, said second set is held stationary at said loading zone while a second group of articles is transferred from said staging means to said loading zone.

2. The article metering system of claim 1, wherein said control means further controls said second set of conveying elements to move said second group of articles to said exit point, and for further controlling said first set of conveying elements such that after said second group of articles is moved from said loading zone, said first set is returned to said loading zone.

3. The article metering system of claim 1 wherein the control means further controls the sets of conveying elements such that if a group of articles is not present at said loading zone, a waiting set of conveying elements is held stationary at said loading zone only a predetermined period before being moved to said exit point.

4. The article metering system of claim 1 wherein the control means further controls the sets of conveying elements such that if a group of articles is not present at said loading zone, a waiting set of conveying elements is held stationary at said loading zone until a group of articles becomes present at said loading zone.

5. The article metering system of claim 4 wherein the or each other of said sets of conveying elements are held stationary on said conveyor during the stationary period of said waiting set of conveying elements.

6. The article metering system of claim 1 wherein groups of articles are supplied in layers from the staging means to the loading zone in order to minimize or eliminate empty space between groups of containers at the loading zone.

7. The article metering system of claim 1 further comprising a transfer element disposed at the exit point of the conveyor for receiving a metered stream of articles and for transferring said metered stream of articles to a processing device.

8. The article metering system of claim 1 comprising a delivery mechanism for delivering a plurality of articles to the staging means.

9. A method of metering articles, such as containers, comprising:
(i) providing a plurality of articles to a staging means;
(ii) conveying said plurality of articles from a loading zone to an exit point using at least two independent sets of conveying elements;
(iii) supplying a group comprising a predetermined number of articles from said staging means to said loading zone; and
(iv) controlling said sets of conveying elements whereby a first of said sets is held stationary at said loading zone while a first group of articles is supplied from said staging means to said loading zone, and is thereafter controlled to move said first group of articles to said exit point, and for controlling a second set of conveying elements such that after said first group of articles is moved from said loading zone, said second set is held stationary at said loading zone while a second group of articles is transferred from said staging means to said loading zone.

10. The method of claim 9, wherein said step of controlling further comprises controlling said second set of conveying elements to move said second group of articles to said exit point, and for further controlling said first set of conveying elements such that after said second group of articles is moved from said loading zone, said first set is returned to said loading zone.

11. The method of claim 9 wherein the step of controlling further comprises controlling the sets of conveying elements such that if a group of articles is not present at said loading zone, the waiting set of conveying elements is held stationary at said loading zone only a predetermined period before being moved to said exit point.

12. The method of claim 9 wherein the step of controlling further comprises controlling the sets of conveying elements such that if a group of articles is not present at said loading zone, the waiting set of conveying elements is held stationary at said loading zone until a group of articles becomes present at said loading zone.

13. The method of claim 12 wherein the step of controlling comprises controlling the or each other of said sets of conveying elements such that they are held stationary on said conveyor during the stationary period of said waiting set of conveying elements.

14. The method of claim 9 further comprising supplying groups of articles in layers from the staging means to the loading zone in order to minimize or eliminate empty space between groups of containers at the loading zone.

15. The method of claim 9 further comprising transferring a metered stream of articles from the exit point to a processing device.

16. The method of claim 9 further comprising delivering a plurality of articles to the staging means.

17. A packaging apparatus for filling and packaging containers comprising a filling station, a packaging section and an article metering system according to claim 1 for supplying a metered stream of containers to the filling station for filling, the packaging apparatus further comprising a transfer mechanism for transferring filled containers to the packaging section wherein multiple containers are packaged together in groups.

18. A control unit for use in a metering system according to claim 1.

19. A control unit for carrying out step (iii) of the method of claim 9.
